(19) United States
(12) Patent Application Publication
(10) Pub. No.: US 2016/0110052 A1
(43) Pub. Date: Apr. 21, 2016

(54) APPARATUS AND METHOD OF DRAWING AND SOLVING FIGURE CONTENT

(71) Applicant: Samsung Electronics Co., Ltd., Suwon-si (KR)

(72) Inventors: Sang-ho KIM, Hwaseong-si (KR); Jae-kyung KWAK, Ansan-si (KR); Dong-chang LEE, Suwon-si (KR); Dong-hyuk LEE, Seoul (KR); Won-hee LEE, Suwon-si (KR); Jae-woong LEE, Suwon-si (KR); Ho-young JUNG, Hwaseong-si (KR); Seong-taek HWANG, Pyeongtaek-si (KR); Do-hyeon KIM, Suwon-si (KR); Jung-rim KIM, Yongin-si (KR); Jeong-wan PARK, Seoul (KR)

(21) Appl. No.: 14/882,717

(22) Filed: Oct. 14, 2015

(30) Foreign Application Priority Data
Oct. 20, 2014 (KR) 10-2014-0141695

(51) Int. Cl. G06F 3/0488; G06T 11/20

(52) U.S. Cl. CPC G06F 3/0488; G06T 11/203

(57) ABSTRACT

A touchscreen apparatus for styling a content is provided. The touchscreen apparatus for drawing a figure content includes an input device receiving a touch input of a figure from a user and receiving an input related to configuration information of the figure, a processor configured to reconstruct the figure, which is pre-stored, based on at least one of the received touch input and the received configuration information of the figure to obtain a reconstructed figure, and a display configured to display the reconstructed figure on a screen, wherein the configuration information of the figure includes at least one of information indicating a length of the figure and information indicating an angle of the figure.

### CROSS-REFERENCE TO RELATED APPLICATION(S)

This application claims the benefit under 35 U.S.C. §119(a) of a Korean patent application filed on Oct. 20, 2014 in the Korean Intellectual Property Office and assigned Serial number 10-2014-0141695, the entire disclosure of which is hereby incorporated by reference.

### TECHNICAL FIELD

The present disclosure relates to methods of drawing and solving a figure content on a touchscreen apparatus and touchscreen apparatuses using the methods.

### BACKGROUND

Examples of an input method include using a keypad and using a touchscreen. The use of a touchscreen involves providing a touch recognition device in a screen of a device and receiving a user's touch input.

A device to which an input method using a touchscreen is applied is used as an input device for various electric/electronic apparatuses including a portable terminal such as a mobile phone (e.g., a smart-phone), a Moving Picture Experts Group phase 1 or phase 2 (MPEG-1 or MPEG-2) audio layer 3 (MP3) player, a personal digital assistant (PDA), a portable multimedia player (PMP), a PlayStation® portable (PSP), a portable game console, or a digital multimedia broadcasting (DMB) receiver, a monitor of a navigation system, an industrial terminal, a notebook computer, an automatic teller machine (ATM), or a game console, and an electric home appliance such as a refrigerator, a microwave oven, or a washing machine.

Also, as digital content has developed, a virtual reality program using a digital device has been attempted in various fields. Also, as touch input technology has been developed, a user may perform various touch operations such as drag, flick, swipe, and pinch on a device by using an input tool. As various touch operations may be performed on a device, the sense of reality felt by a user who is exposed to an event that occurs in response to a touch operation performed on the device has increased. Accordingly, a virtual reality program using a device to which an input method using a touchscreen is applied has been attempted in various fields.

In particular, as a touchscreen apparatus such as a tablet personal computer (PC) has recently been used as an education material for students, there is a demand for a technology of displaying and editing content or teaching plans on the touchscreen apparatus. In detail, as various education and learning activities using figure contents have been conducted, there is a demand for a method of easily drawing and editing figures and solving the drawn and edited figures.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide methods and apparatuses for drawing and solving figure contents on a touchscreen apparatus, and more particularly, methods and apparatuses for drawing and editing figure contents and displaying information about the figure contents.

In accordance with an aspect of the present disclosure, a method of drawing a figure content on an apparatus is provided. The method includes receiving a touch input of a figure from a user, receiving an input related to configuration information of the figure, reconstructing a figure, which is pre-stored, based on at least one of the received touch input and the received configuration information of the figure to form a reconstructed figure, and displaying the reconstructed figure on a touchscreen, wherein the configuration information of the figure includes at least one of information indicating a length of the figure and information indicating an angle of the figure.

The received touch input of the figure may include at least one of a swipe input of a side of a figure to be drawn and a touch input that selects a figure that is pre-stored in the touchscreen apparatus.

The method may further include displaying information of the touch input on the touchscreen.

When it is determined that the figure that is pre-stored is not reconstructable based on at least one of the received touch input and the received configuration information of the figure, the method may include displaying an object indicating that no figure is drawn on the touchscreen.

The receiving of the input related to the configuration information of the figure may include, when the configuration information of the figure is length information, receiving the input related to the configuration information of the figure on a side of the figure or in an area within a predetermined distance from the side of the figure.

The length information may include at least one of a value of a length of the side of the figure and a preset object indicating a relative length to other sides.

The receiving of the input related to the configuration information of the figure may include, when the figure is a circular figure, receiving an input related to an auxiliary line indicating a diameter or a radius of the circular figure and then receiving length information indicating the diameter or the radius of the circular figure.

The receiving of the input related to the configuration information of the figure may include, when the figure is a solid figure, receiving an input about an auxiliary line indicating a height of the solid figure and then receiving length information indicating the height of the solid figure.

The receiving of the input related to the configuration information of the figure may include, when the configuration information of the figure is angle information, receiving the input related to the configuration information of the figure in an area with a predetermined distance from a contact point at which two sides constituting the angle information meet each other.

The angle information may include at least one of a value of an angle and a preset angle marking object.

In accordance with another aspect of the present disclosure, a method of editing a figure content on a touchscreen apparatus is provided. The method includes displaying a figure on a touchscreen, receiving an input related to configuration information of the figure from a user, reconstructing the figure displayed on the touchscreen based on the received configuration information of the figure to obtain a reconstructed figure, and displaying the reconstructed figure on the touchscreen, wherein the configuration information of the figure includes at least one of information indicating a length of the figure and information indicating an angle of the figure.

The received input related to the configuration information of the figure may include at least one of a swipe input of a side of a figure to be edited and a touch input that selects a figure that is pre-stored in the touchscreen apparatus.

The method may further include receiving a touch input that eliminates a part or the whole of the configuration information of the figure displayed on the touchscreen.

When it is determined that the pre-stored figure is not reconstructable based on the received configuration information of the figure, the method may include displaying an object indicating that no figure is drawn on the touchscreen.

The receiving of the input related to the configuration information of the figure may include, when the configuration information of the figure is length information, receiving the input related to the configuration information of the figure on a side of the figure or in an area within a predetermined distance from the side of the figure.

The length information may include at least one of a value of a length of the side of the figure and a preset object indicating a relative length to other sides.

The receiving of the input related to the configuration information of the figure may include, when the figure is a circular figure, receiving an input related to an auxiliary line indicating a diameter or a radius of the circular figure and then receiving length information indicating the diameter or the radius of the circular figure.

The receiving of the input related to the configuration information of the figure may include, when the figure is a solid figure, receiving an input related to an auxiliary line indicating a height of the solid figure and then receiving length information indicating the height of the solid figure.

The receiving of the input related to the configuration information of the figure may include, when the configuration information of the figure is angle information, receiving the input related to the configuration information of the figure in an area within a predetermined distance from a contact point at which two sides constituting the angle information meet each other.

The angle information may include at least one of a value of an angle and a preset angle marking object.

In accordance with another aspect of the present disclosure, a method of displaying information related to a figure content on a touchscreen apparatus is provided. The method includes displaying a figure on a touchscreen, receiving an input that requests for configuration information of the figure, calculating the requested configuration information of the figure by using a preset formula, and displaying the calculated configuration information of the figure on the touchscreen, wherein the configuration information of the figure includes at least one of information indicating a length of the figure and information indicating an angle of the figure.

The requested configuration information of the figure may include at least one of length information, angle information, area information, and volume information of the figure.

The receiving of the input that requests for the configuration information of the figure may include receiving an input related to a request object or preset request text.

The receiving of the input that requests for the configuration information of the figure may include, when the requested configuration information of the figure is length information, receiving the input that requests for the configuration information of the figure on a side of the figure or in an area within a predetermined distance from the side of the figure.

The receiving of the input that requests for the configuration information of the figure may include, when the requested figure is a circular figure, receiving an input related to an auxiliary line indicating a diameter or a radius of the circular figure and then receiving an input that requests for length information indicating the diameter or the radius of the circular figure.

The receiving of the input that requests for the configuration information of the figure may include, when the requested figure is a solid figure, receiving an input related to an auxiliary line indicating a height of the solid figure and then receiving an input that requests for length information indicating the height of the solid figure.

The receiving of the input that requests for the configuration information of the figure may include, when the configuration information of the figure is angle information, receiving the input that requests for the configuration information of the figure in an area within a predetermined distance from a contact point at which two sides constituting the angle information meet each other.

In accordance with another aspect of the present disclosure, a touchscreen apparatus for drawing a figure content is provided. The touchscreen apparatus includes an input device configured to receive a touch input of a figure from a user and receive an input related to configuration information of the figure, a processor configured to reconstruct the figure, which is pre-stored, based on at least one of the received touch input and the received configuration information of the figure to obtain a reconstructed figure, and a display configured to display the reconstructed figure on a screen, wherein the configuration information of the figure includes at least one of information indicating a length of the figure and information indicating an angle of the figure.

In accordance with another aspect of the present disclosure, a touchscreen apparatus for editing a figure content is provided. The touchscreen apparatus includes an input device configured to receive an input related to configuration information of a figure from a user, a processor configured to reconstruct the figure displayed on a touchscreen based on the received configuration information of the figure to obtain a reconstructed figure, and a display configured to display the reconstructed figure on the touchscreen, wherein the configuration information of the figure includes at least one of information indicating a length of the figure and information indicating an angle of the figure.

In accordance with another aspect of the present disclosure, a touchscreen apparatus for displaying information related to a figure content is provided. The touchscreen apparatus includes an input device configured to receive an input that requests for configuration information of a figure, a control unit configured to calculate the requested configuration information of the figure by using a preset formula, and a display configured to display the calculated configuration information of the figure on a touchscreen, wherein the configuration information of the figure includes at least one of information indicating a length of the figure and information indicating an angle of the figure.

In accordance with another aspect of the present disclosure, a non-transitory computer-readable recording medium has embodied thereon a program for executing in a computer the method.

In accordance with another aspect of the present disclosure, a computer program that is stored in a computer readable medium to cause a processor to receive a touch input of a figure from a user, receive an input related to configuration information of the figure from the user, reconstruct a figure, which is pre-stored, based on at least one of the received touch input and the received configuration information of the figure to obtain a reconstructed figure, and display the reconstructed figure on a screen, wherein the configuration information of the figure includes at least one of information indicating a length of the figure and information indicating an angle of the figure.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a touchscreen apparatus according to an embodiment of the present disclosure;

FIG. 2 illustrates an input tool that inputs information into the touchscreen apparatus according to an embodiment of the present disclosure;

FIG. 3 is a flowchart of a process of drawing a figure content according to an embodiment of the present disclosure;

FIGS. 4A and 4B are screens illustrating a method of drawing a figure content according to various embodiments of the present disclosure;

FIGS. 5A, 5B, 5C, 5D, 6A, and 6B are screens illustrating a method of inputting length information and angle information of a figure content according to various embodiments of the present disclosure;

FIGS. 7A, 7B, and 7C are screens illustrating a method of inputting length information and angle information of a figure content according to various embodiments of the present disclosure;

FIGS. 8A, 8B, and 8C are screens illustrating a method of inputting length information of a solid figure content according to various embodiments of the present disclosure;

FIGS. 9A and 9B are screens illustrating a method of inputting text information to a figure content according to various embodiments of the present disclosure;

FIG. 10 is a flowchart of a process of editing a figure content according to an embodiment of the present disclosure;

FIGS. 11A, 11B, and 11C are screens illustrating a method of editing a length of a figure content according to various embodiments of the present disclosure;

FIGS. 12A and 12B are screens illustrating a method of editing an angle of a figure content according to various embodiments of the present disclosure;

FIGS. 13A, 13B, 13C, and 13D are screens illustrating a method of editing a figure content according to various embodiments of the present disclosure;

FIG. 14 is a flowchart of a process of displaying information about a figure content according to an embodiment of the present disclosure;

FIGS. 15A and 15B are screens illustrating a method of displaying information about a figure content according to various embodiments of the present disclosure;

FIGS. 16A and 16B are screens illustrating a method of displaying information about a solid figure content according to various embodiments of the present disclosure; and

FIG. 17 is a screen illustrating a method of displaying angle information of a figure content according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “touch input” used herein refers to a user's gesture that is input on a touchscreen to control a device. Also, the touch input may include a touch (e.g., a floating or hovering touch) that is made while a finger or a touch tool (e.g., a stylus pen) is spaced apart from the touchscreen, instead of contacting the touchscreen.

Examples of the touch input used herein may include a drag, a flick, a tap, a double tap, and a swipe.

The term “drag” refers to a gesture that is input when a user touches a screen by using his/her finger or a touch tool and then moves his/her finger or the touch tool that continuously contacts the screen to another location on the screen.

The term “tap” refers to a gesture that is input when a user touches a screen by using his/her finger or a touch tool (e.g., an electronic pen) and then quickly lifts up his/her finger or the touch tool from the screen without moving to another location.

The term “double tap” refers to a gesture that is input when a user touches a screen twice by using his/her finger or a touch tool.

The term “flick” refers to a gesture that is input when a user performs a drag operation at a speed equal to or higher than a critical speed by using his/her finger or a touch tool. Although “drag” and “flick” may be distinguished from each other based on whether a speed at which a finger or a touch tool moves is equal to or higher than a critical speed, the term “flick” used herein is construed to be included in “drag”.

The term “swipe” refers to a gesture that is input when a user touches a predetermined area on a screen by using his/her finger or a touch tool, the user horizontally or vertically moves by a predetermined distance his/her finger or the touch tool. A diagonal movement may not be recognized as a swipe event. The term “swipe” used herein is construed to be included in “drag”.

Also, the term “touch and hold” refers to a gesture that is input when a user touches a screen by using his/her finger or a touch tool and then maintains the touch for a predetermined period of time. That is, a “touch and hold” refers to a gesture that is made when a time difference between a touch-in time and a touch-out time is equal to or greater than the predetermined period of time. A “touch and hold” may be interchangeably used with “long press”. To enable a user to know whether a touch input is a “tap” or a “touch and hold”, a feedback indication may be visually or audibly provided to the user.

The term “drag and drop” refers to a gesture that is input when a user drags identification information of an application by using his/her finger or a touch tool on a screen and puts the identification information in a location within the screen.

The term “pinch to zoom” refers to a gesture that is input when a user widens or narrows an interval between two or more fingers or touch tools. When a user widens an interval between fingers, it may be used as an input that increases a size of a screen displayed on a touchscreen, and when the user narrows the interval between the fingers, it may be used as an input that reduces the size of the screen displayed on the touchscreen.

The term “motion input” used herein refers to a gesture that is provided to a device to control the device. Examples of the motion input may include a rotation of the device, a tilting of the device, and movement of the device in four directions. The device may detect the motion input by the user by using an acceleration sensor, a tilt sensor, a gyro sensor, or a 3-axis magnetic sensor.

The term “bending input” refers to a gesture that is input when an electronic device is a flexible display device and a user bends a part or the whole of the electronic device in order to control the electronic device. According to an embodiment of the present disclosure, the electronic device may detect a bending location (coordinates), a bending direction, a bending angle, a bending speed, the number of bending operations, a time at which a bending operation starts, and a period of time for which a bending operation is maintained by using a bending sensor.

The term “key input” used herein refers to an input that is applied when a user controls a device by using a physical key attached to the device, and also refers to an input that is applied when a user controls a device by using a soft key displayed on a display unit of the device. The term “soft key” refers to a key that provides an environment in which a touch input may be performed on a virtual keypad displayed on a display unit. Accordingly, it will be understood that “key input” may be interchangeably used with “touch input”.

The term “multimodal input” used herein refers to a combination of at least two types of inputs. For example, a device may receive a user's touch input and motion input, or may receive a user's touch input and voice input. Also, a device may receive a user's touch input and retina input. The term “retina input” refers to an input that is applied when a user adjusts an eye blink, a gazing point, a speed at which an eyeball moves, and so on in order to control a device.

According to various embodiments of the present disclosure, a device may include a communication unit that receives an application execution command from an external device (not shown) that is connected to the device.

Examples of the external device may include, but are not limited to, a mobile phone, a smart-phone, a notebook personal computer (PC), a tablet PC, an electronic book terminal, a digital broadcasting terminal, a personal digital assistant (PDA), a portable multimedia player (PMP), a navigation system, and a Moving Picture Experts Group phase 1 or phase 2 (MPEG-1 or MPEG-2) audio layer 3 (MP3) player.

For example, a user may request to execute an application provided in a device by using an external device such as a mobile phone, a smart-phone, a notebook computer, a tablet PC, or a navigation system that is connected to the device. The external device may transmit an application execution command to the device by using short-range communication (e.g., Bluetooth®, near field communication (NFC), wireless fidelity (Wi-Fi) or Wi-Fi direct (WFD)).

According to an embodiment of the present disclosure, a device may execute an application in response to a user's input. The user's input may request to execute the application. Also, the device may execute the application after receiving an execution command from an external device (not shown) that is connected to the device.

As used herein, the term “and/or” includes any and all combinations of one or more of the associated listed items. Expressions such as “at least one of,” when preceding a list of elements, modify the entire list of elements and do not modify the individual elements of the list.

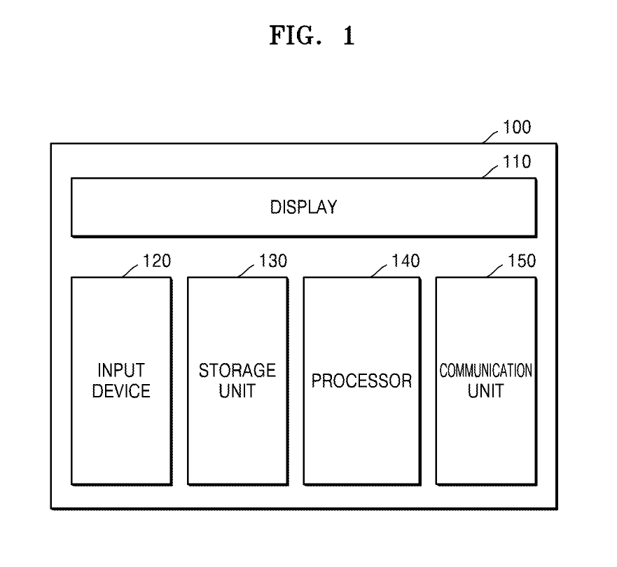

FIG. 1 is a block diagram of a touchscreen apparatus according to an embodiment of the present disclosure.

Referring to FIG. 1, a touchscreen apparatus 100 may include a display unit 110, an input device 120, a storage unit 130, a control unit 140, and a communication unit 150.

The display unit 110 may display a screen of a program that is running in the touchscreen apparatus 100. The display unit 110 may include an image panel such as a liquid crystal panel or an organic light-emitting panel, and may display a graphical user interface (GUI) of a software (SW) application, a function setting, and a content (hereinafter, referred to as an operation menu) such as music, a photograph, or a video.

The input device 120 may receive an input according to the user's operation of the touchscreen apparatus 100, for example, the user's touch input, button input, or pen input. For example, the touch input may be applied to a touchscreen that is the display unit 110.

The storage unit 130 may convert external signals into data and may store the data. The user's input information that is received by the touchscreen apparatus 100 may be accumulated and stored in the storage unit 130, and an attribute value before and after a figure content is drawn and edited may be cancelled and removed. Other data that is transmitted from an external device or a server through the communication unit 150 may be stored in the storage unit 130.

The control unit 140 may determine a figure content that is input through the user's input. Alternatively, the control unit may calculate the figure content by using a mathematical formula, which will be explained below.

The communication unit 150 may receive an application execution command from the external device that is connected to the touchscreen apparatus 100. Examples of the external device may include, but are not limited to, a mobile phone, a smart-phone, a notebook computer, a tablet PC, an electronic book terminal, a digital broadcasting terminal, a PDA, a PMP, a navigation system, an MP3 player, a Bluetooth® keyboard, and a Bluetooth® mouse. For example, the user may request to execute an application that is provided in the touchscreen apparatus 100 through the external device such as a mobile phone, a smart-phone, a notebook computer, a tablet PC, or a navigation system that is connected to the touchscreen apparatus 100. The external device may transmit an application execution command to the touchscreen apparatus 100 by using short-range communication (e.g., Bluetooth®, NFC, or WFD).

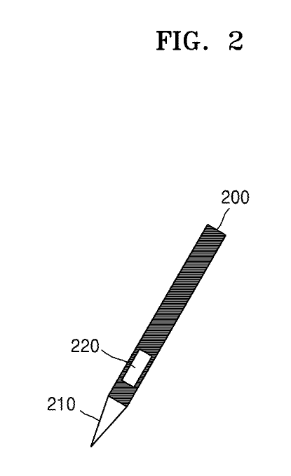

FIG. 2 illustrates an input tool that inputs information into a touchscreen apparatus according to an embodiment of the present disclosure.

Referring to FIG. 2, the touchscreen apparatus 100 may receive the user's input by using the user's body part such as a finger or an input tool 200 such as a stylus pen.

When a pen input is provided using a stylus pen, a contact unit 210 outputs an electromagnetic signal to the touchscreen apparatus 100 and a button 220 for performing various operations using the stylus pen may be further included.

When the input device 120 detects a contact of the input tool 200, the input device 120 may determine a contact location of the input tool 200. The contact location may be a location of the user's input. The input device 120 may detect an approach of the input tool 200. When the touchscreen apparatus 100 includes a capacitive sensor, the input device 120 may detect a change in a capacitance under a surface of a touchscreen. The touchscreen apparatus 100 may include a magnetic field sensor or an electromagnetic induction apparatus. In this case, when a magnetic field is changed in an electromagnetic space, the touchscreen apparatus 100 may detect a contact or an approach of the input tool 200 and may determine an input location of the input tool 200.

The control unit 140 may determine the user's control command based on an input of the input tool 200. The control unit 140 may control the touchscreen apparatus 100 by searching for a control command corresponding to the received input in interaction database (DB) information that is stored in the storage unit 130.

Although various methods of styling a content may be explained by using a touch input using the user's body part such as a finger, since content styling in the present disclosure relates to the touchscreen apparatus 100 that is used as a teaching and learning material, experiential user interaction may be provided through a pen input of a teaching and learning tool. It will be understood by one of ordinary skill in the art that the present disclosure is not limited to a pen input and the user's touch input may be used.

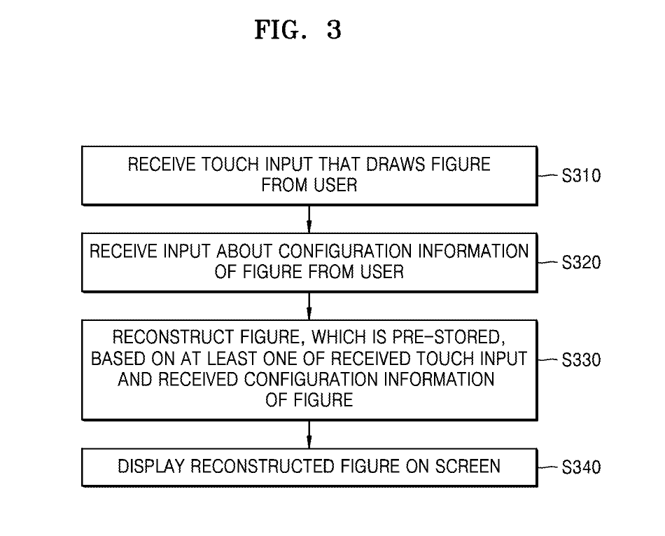

FIG. 3 is a flowchart of a process of drawing a figure content according to an embodiment of the present disclosure.

Referring to FIG. 3, in operation S310, an input device may receive a touch input of a figure that is drawn by a user. The touch input may be a part of the figure or the whole figure. The figure may be a plane figure such as a circle, a triangle, or a quadrangle or a solid figure such as a cylinder, a cone, or a tetrahedron.

In operation S320, the input device may receive an input related to configuration information of the figure from the user. The configuration information may be length information or angle information. In the present disclosure, the length information may include various units. The length information may include a standard unit such as a centimeter (cm) or a millimeter (mm), and a length unit on a touchscreen such as a pixel. The length information will be explained while omitting a unit, for convenience. The angle information will be explained by using a unit of degree °.

In operation S330, a control unit may reconstruct a figure, which is pre-stored, based on at least one of the received touch input and the received configuration information of the figure to obtain a reconstructed figure. A storage unit may include a figure DB that stores plane figures such as circles, triangles, and quadrangles and solid figures such as cylinders, cones, and regular tetrahedrons.

In operation S340, a display unit may display the reconstructed figure on a screen. When the reconstructed figure is a plane figure that is a two-dimensional (2D) figure (i.e., a plane figure), the display unit may display the reconstructed figure on the touchscreen whereas when the reconstructed figure is a solid figure that is a three-dimensional (3D) figure (i.e., a solid figure), the display unit may display the reconstructed figure as a side view or the like on the touchscreen.

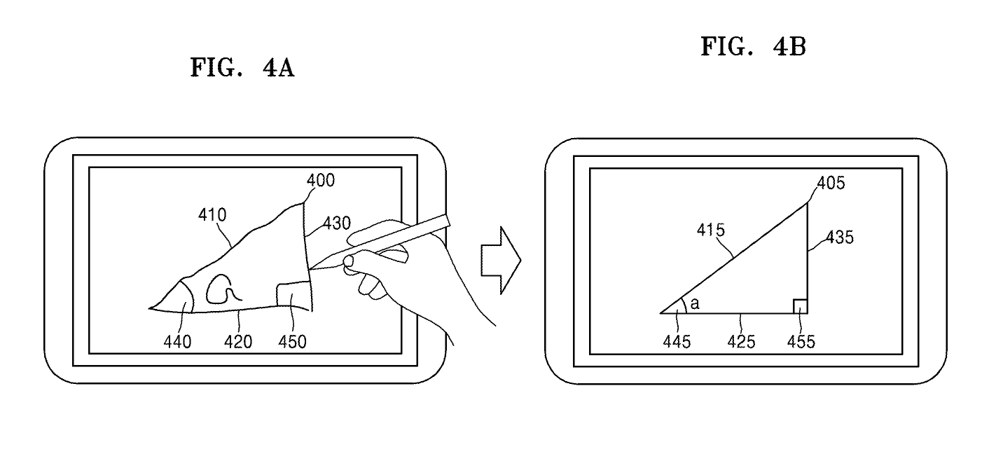

FIGS. 4A and 4B are screens illustrating a method of drawing a figure content according to various embodiments of the present disclosure.

Referring to FIG. 4A, an input device may receive an input of a figure drawn by a user. The input device may receive a drag input indicating three sides 410, 420, and 430 of a triangle 400 from the user. Also, the input device may receive a drag input of an angle symbol 440 indicating an angle between the side 410 and the side 420. The input device may receive a drag input of an angle symbol 450 indicating a right angle.

Angle information including the angle symbols 440 and 450 is configuration information of the triangle 400, and is used to form the figure along with length information indicating a length of each side. For example, as shown in FIG. 4A, when the angle symbols 440 and 450 respectively indicate an angle 440 of a° and an angle of 90°, since a sum of interior angles of the triangle 400 is 180°, a remaining angle between the side 410 and the side 430 is (90-a)°. Accordingly, since the touchscreen apparatus may calculate three interior angles of the triangle 400, the touchscreen apparatus may draw a figure content 405. Referring to FIG. 4B, when a length of at least one of the three sides 410, 420, and 430 is given, the touchscreen apparatus may draw the figure content 405 with an exact size.

The touchscreen apparatus may display a figure list, which is pre-stored, on the touchscreen apparatus and may receive an input that selects a figure from the user. Figures from the figure list may be divided into triangles and quadrangles. If the figures are quadrangles, the quadrangles may be divided into trapezoids, parallelograms, and rhombuses.

Since the angle 440 of a° is not input as a specific value in FIG. 4A, the figure content 405 may be drawn to have an angle of a° in FIG. 4B. The drawn figure content 405 includes three sides 415, 425, and 435 that are straight lines and more accurate figure than the triangle 400 that is input by the user. A length of the side 415 of the figure content 405 may be equal to a length of the side 410 of the triangle 400. That is, the side 415 may be drawn as an oblique side by linearly connecting a start coordinate point and an end coordinate point of an oblique side of the triangle 400, and the same method may apply to the sides 425 and 435.

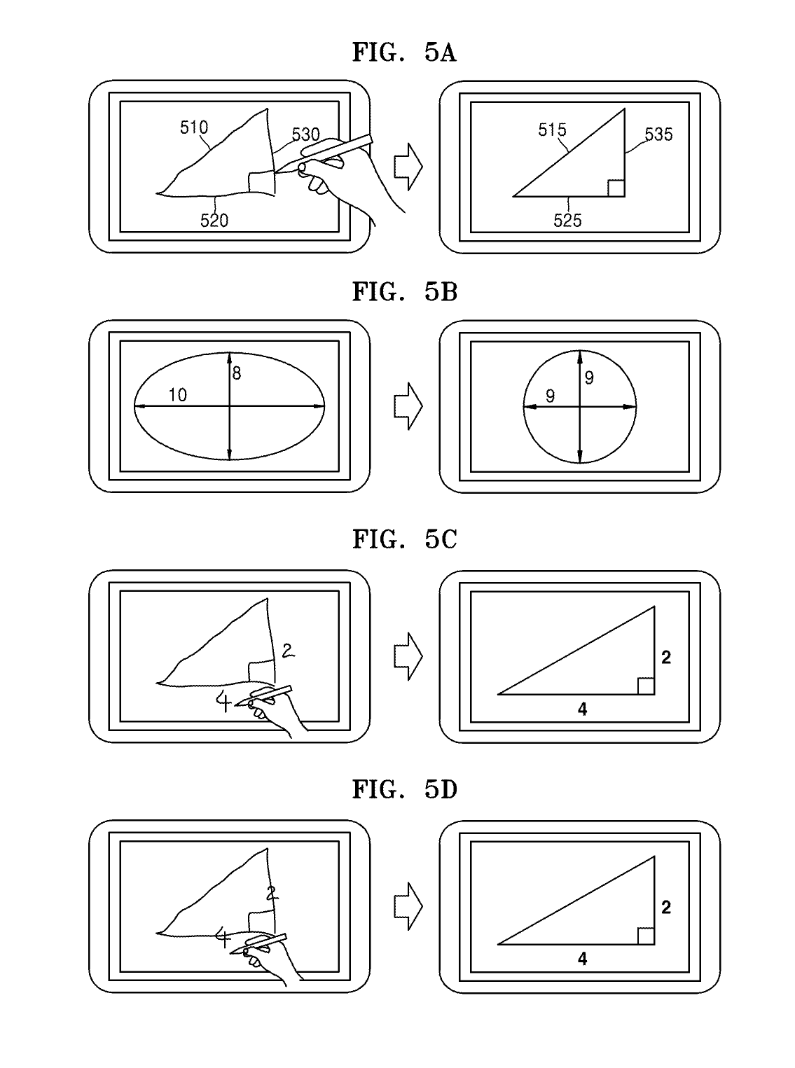

FIGS. 5A 5B, 5C, 5D, 6A, and 6B are screens illustrating a method of inputting length information and angle information of a figure content according to various embodiments of the present disclosure.

Referring to FIG. 5A, an input device of a touchscreen apparatus may receive an input of length information including sides 510, 520, and 530 and angle information, which are used to determine and display a figure content on a touchscreen. When a specific value for the length information and the angle information is not received from the user, the touchscreen apparatus may draw the figure content by connecting coordinates of vertices of the input.

Referring to FIG. 5B, when a figure has no vertex (e.g., a circle), a maximum value and a minimum value of a diameter or a radius may be calculated and may be generated as an average value. For example, when a largest diameter of the circle input by the user is 10 and a smallest diameter of the circle input by the user is 8, the touchscreen apparatus may draw and display a circular content having a diameter of 9 that is an average value.

To draw a figure content desired by the user, the input device may receive a length or an angle. Angle information is not changed even when a figure content is displayed on the touchscreen after being increased or reduced in terms of an angle. However, as for length information, the user may input a value larger than a size of the touchscreen, or may input a value smaller than the size of the touchscreen and thus a figure content may not be visible. Accordingly, the length information input by the user may be used so that a figure content is displayed to have the length information. However, if it is difficult to display the figure content having the length information, the figure content may be increased or reduced and then may be displayed.

Referring to FIG. 5C, length information of a figure content may be received in an area that is near to each side. When a value or text is input in an area that is within a predetermined distance from each side, the touchscreen apparatus may determine which side receives the length information and may display the side to have the value or text. As shown in FIG. 5C, when length information and angle information of a right triangle having a bottom side of 4 and a height of 2 is drawn on the touchscreen, a right triangle content may be drawn by using the length information.

However, it may be difficult to determine which side receives the input value. For example, when a specific value is input in an area that is near to a vertex having a right angle, it may be difficult to determine whether the specific value is length information for a bottom side or length information for a height.

Referring to FIG. 5D, the touchscreen apparatus may receive length information on the side by intersecting the length information with the corresponding side. Likewise, angle information may also be received on an angle mark. In this case, it may accurately determine which side or angle receives the input.

When an input of length information and angle information is received, the touchscreen may not draw a figure content based on the input information. For example, when the input information does not satisfy properties of a figure, a figure content satisfying the input may not be drawn.

For example, properties of a triangle are as follows.

i) A sum of lengths of two sides of a triangle is greater than a length of the remaining side.

ii) A sum of three interior angles of a triangle is 180°.

iii) An exterior angle of a triangle is equal to a sum of two interior angles that are not adjacent to the exterior angle.

Accordingly, when length information or angle information that does not satisfy the properties i) through iii) is input, a figure content may not be drawn.

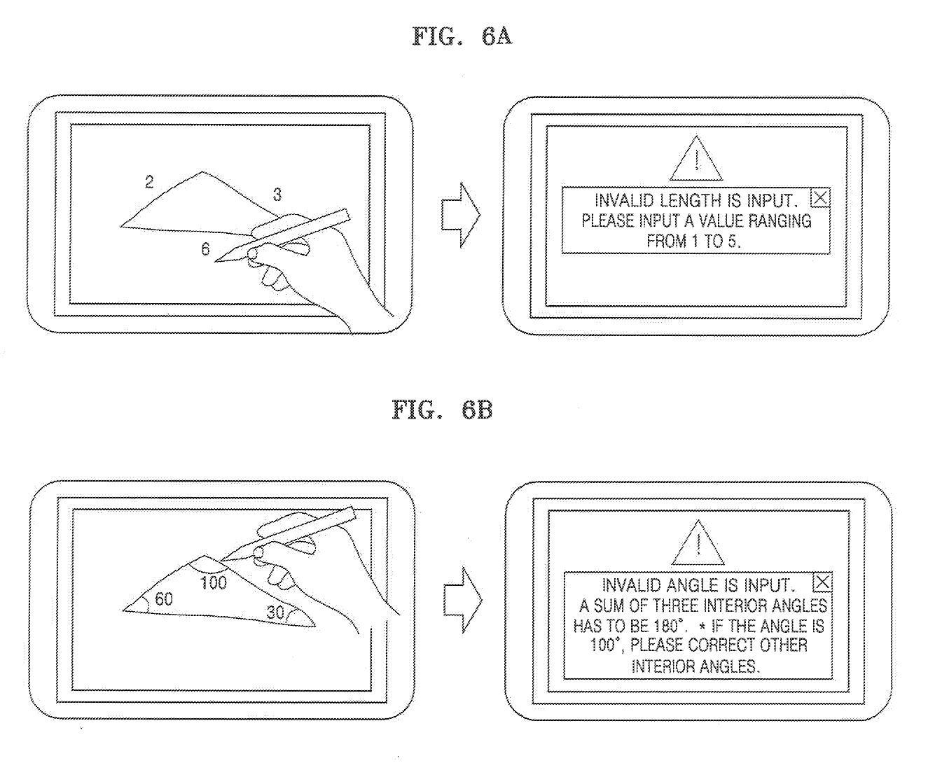

Referring to FIG. 6A, the touchscreen apparatus may receive length information or angle information that may not be used to draw a figure content from the user. As shown in FIG. 6A, when length information indicating that lengths of three sides of a triangle are 2, 3, and 6 is input, because 6 is a largest length among the lengths of the three sides is greater than the sum of the lengths of the other two sides (i.e., 5), the control unit may determine that the input length information does not satisfy the property i) of the triangle.

Accordingly, the control unit of the touchscreen apparatus may display on the touchscreen that a figure content may not be drawn by using the input length information. For example, the control unit may display text information saying, for example, “invalid length is input” on the touchscreen. The displayed text information may be output on the touchscreen apparatus as any of various types such as a sound or a vibration. The control unit of the touchscreen apparatus may control an appropriate range of length information to be displayed in order to receive the length information satisfying the properties i) through iii).

Referring to FIG. 6B, when angle information indicating that three interior angles of a triangle are 30°, 60°, and 100° is input, because the angle information does not satisfy the property ii), the control unit may determine that a figure content may not be drawn by using the input angle information. The touchscreen apparatus may display text information saying, for example, “invalid angle is input” and the displayed text information may be output as any of various types, as described above with reference to FIG. 6A. In order to receive angle information satisfying the properties i) through iii), the control unit of the touchscreen apparatus may display a popup message or the like to request the user to correct the angle information. For example, when angle information indicating that two interior angles of a triangle are 30° and 60° is input, the control unit may automatically calculate the remaining interior angle as 90° according to the property ii). Accordingly, the control unit may additionally perform a process of determining whether an angle that is input by the user is 100° or 90°.

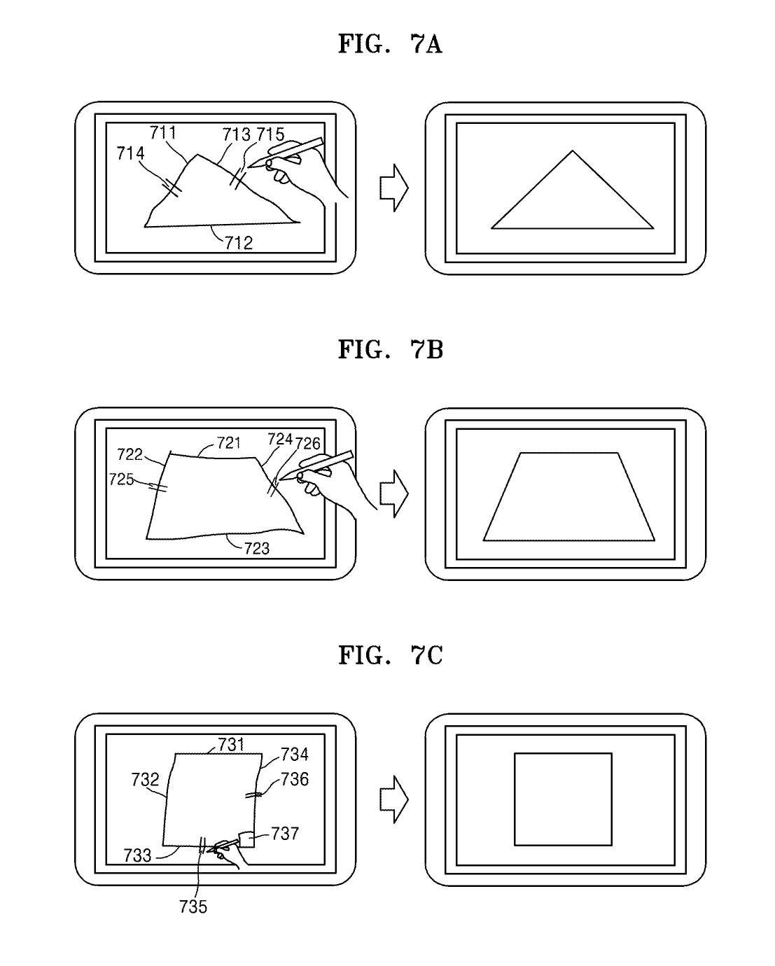

FIGS. 7A 7B, and 7C are screens illustrating a method of inputting length information and angle information of a figure content according to various embodiments of the present disclosure.

Referring to FIG. 7A, the input device may receive the user's input that draws an isosceles triangle. After receiving an input that draws three sides 711, 712, and 713, the input device may also receive equilateral symbols 714 and 715 indicating that lengths of the sides 711 and 713 are equal to each other. Since an isosceles triangle has a property that lengths of two sides are equal, the touchscreen apparatus may draw a figure content so that lengths of the two sides 711 and 713 indicated by the equilateral symbols 714 and 715 are equal. An equilateral symbol is used as a symbol indicating a relative length to other sides, instead of absolute length information that is input that indicates a fixed length of a side.

To accurately determine the user's intention, the touchscreen apparatus may draw the figure content by changing a length of the side 713 whose equilateral symbol is input later by using, as reference information, a length of the side 711 whose equilateral symbol is input first. The reason why reference information may be necessary is because, when a figure content has equal sides, the figure content may be accurately drawn by using length information. If reference information is not set, an error of drawing different figure contents even with the same input may occur.

A method of setting reference information may be changed by the user. A length of a side whose equilateral symbol is displayed first may be changed by using, as reference information, a length of a side whose equilateral symbol is displayed later. Alternatively, lengths of two sides may each be changed to an average value of the lengths of the two sides.

Referring to FIG. 7B, the touchscreen apparatus may draw an isosceles trapezoid. The input device of the touchscreen apparatus may receive an input that draws four sides 721 722, 723, and 724 of a quadrangle from the user, and may receive equilateral symbols 725 and 726 indicating that lengths of the sides 722 and 724 are equal to each other.

The touchscreen apparatus may draw and display an isosceles trapezoid content based on received length information. Even in this case, a length of a side whose equilateral symbol is displayed later may be changed by using, as reference information, a length of a side whose equilateral symbol is displayed first.

Referring to FIG. 7C, the input device of the touchscreen apparatus may receive an input that draws four sides 731, 732, 733, and 734 of a quadrangle, and may receive equilateral symbols 735 and 736 indicating that lengths of the sides 733 and 734 that are adjacent to each other are equal to each other. Also, the input device may receive a right angle symbol 737 indicating that an angle between the sides 733 and 734 is a right angle.

The control that receives length information and angle information may draw a figure content satisfying conditions based on the length information and the angle information. In FIG. 7C, because information about lengths of the four sides 731, 732, 733, and 734 is not given, it may not be determined that the figure content is a regular quadrangle. If information indicating that lengths of the four sides 731, 732, 733, and 734 are the same and an angle between adjacent sides is a right angle is received by the touchscreen apparatus, the touchscreen apparatus may draw a regular quadrangle content. However, since length information of the sides 731 and 732 is unclear, lengths of the sides 731 and 732 may be determined and displayed based on coordinates of a start point and an end point that are input.

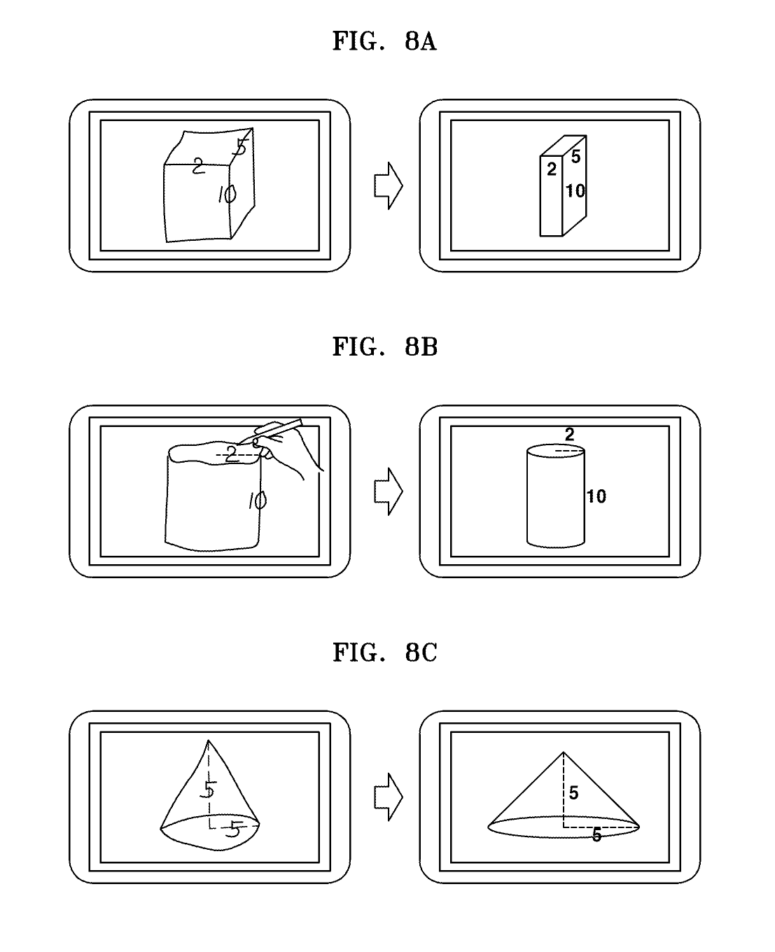

FIGS. 8A, 8B, and 8C are screens illustrating a method of inputting length information of a solid figure content according to various embodiments of the present disclosure.

When a figure content is a solid figure content, since it may be difficult to draw the solid figure content on a plane, the touchscreen apparatus may display the solid figure content as a side view.

Referring to FIGS. 8A, 8B, and 8C, a top surface, a side surface, and a bottom surface may be displayed on the touchscreen. A criterion for determining which one of a top surface and a bottom surface is to be displayed on the touchscreen may be previously set for each solid figure or may be set by receiving the user's input.

Referring to FIG. 8A a hexahedron is drawn and includes a top surface, a bottom surface, and four side surfaces each of which is a quadrangle. Length information of the hexahedron may include lengths of three sides indicating a height, and a horizontal length and a vertical length of the bottom surface. As shown in FIG. 8A, the touchscreen apparatus that receives the length information including the lengths of 2, 5, and 10 from the user may draw a solid figure content satisfying the lengths. Since only the length information is received from the user and angle information is not received, it may be unclear. However, since a hexahedron content having a height of 10 and including the top surface whose lengths are 2 and 5 has to be drawn, each angle may be determined to be a right angle (90°). Alternatively, the touchscreen apparatus may display an angle information input window in order to receive angle information from the user. The touchscreen apparatus may receive angle information between bottom sides and angle information between the bottom sides and a height from the user and may draw a solid figure content matching with the user's intention.

Referring to FIG. 8B, a cylinder is drawn and includes a top surface and a bottom surface that are circles and a side surface. Length information of the circular cylinder may include lengths indicating diameters (or radii) of the top surface and the bottom surface and a height. As shown in FIG. 8B, when a figure is a circular figure, it may be difficult for the user to input length information of the circular figure. For example, when the user inputs 2 as radius information of a circular figure, the touchscreen apparatus may determine 2 as a length of a circumference. Accordingly, it is necessary to distinguish a length of a circumference from a diameter (or a radius) by inputting an auxiliary line.

When an auxiliary line and length information of the auxiliary line are input, the touchscreen apparatus may determine it as the length information of the auxiliary line. As shown in FIG. 8B, since an auxiliary line indicates a radius with length information of 2, the touchscreen apparatus may determine that a radius of a circle is 2 and may draw a circular cylinder content based on the radius of 2. The auxiliary line may be displayed as a dashed line in order to be distinguished from a side of a figure.

Referring to FIG. 8C, a cone may be drawn to include a bottom surface that is a circle and a height or length of an oblique side. In the circular cone, since the circular cone does not have a top surface, the bottom surface may be displayed. As shown in FIG. 8C, when radius information of the circle is input after an auxiliary line is input, the touchscreen apparatus may determine that length information is input as radius information of the circle. Since height information has to be input in the case of a solid figure sometimes, when an auxiliary line connecting a vertex of the circular cone to the bottom surface is input and then length information is input, the length information may be determined as height information of the circular cone. Accordingly, the touchscreen apparatus may draw a circular cone content based on the radius information of the circle and the height information.

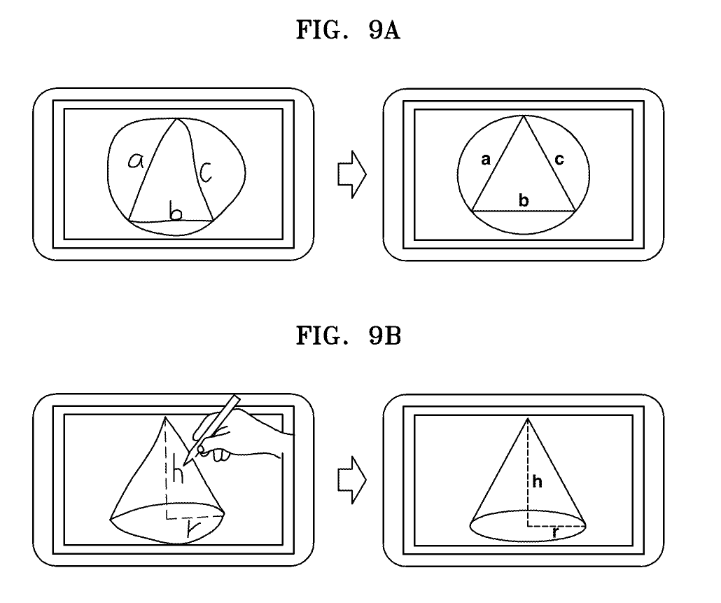

FIGS. 9A and 9B are screens illustrating a method of inputting text information to a figure content according to various embodiments of the present disclosure.

Referring to FIGS. 9A and 9B, the touchscreen apparatus may receive an input of length information or angle information from the user, and may draw a figure content satisfying the length information and the angle information. When a variety of length information and angle information of a figure displayed on the touchscreen are input, because it is unclear whether the information is length information or angle information sometimes, the length information and the angle information may be accurately distinguished by using color information.

The user may apply an input that draws a figure by using an input tool such as a stylus pen, and may apply an input that draws a figure by selecting a specific color in a palette on which various colors are displayed.

The touchscreen apparatus may distinguish a figure content and length information and angle information of the figure content according to color information of the received user's input. For example, when the user inputs a triangle and a circle in the same color such that the circle that contacts the triangle, the touchscreen apparatus may not distinguish the triangle from the circle and may recognize the triangle and the circle as one figure.

Accordingly, the touchscreen apparatus that receives an input in different colors may distinguish each figure as a separate object. Referring to FIG. 9A, when the user inputs a circle in black, inputs a triangle in red, and inputs three sides a, b, and c of the triangle in blue, the control unit of the touchscreen apparatus may recognize each of the circle and the triangle as one object. Also, the user may recognize lengths of the three sides that are input in blue as text and may determine the lengths as variables. The touchscreen apparatus may receive supplemental information indicating that an auxiliary button of the input tool is pressed and may change and display colors of the figures, text, and values based on the supplemental information.

Referring to FIG. 9B, illustrated is a method of inputting height and radius information of a circular cone. When the user inputs a circular cone figure in black and length information such as a radius and a height in red, and an auxiliary line in blue, the touchscreen apparatus may clearly distinguish the circular cone figure and the length information.

A method of editing a figure content drawn by using any of the methods will now be explained.

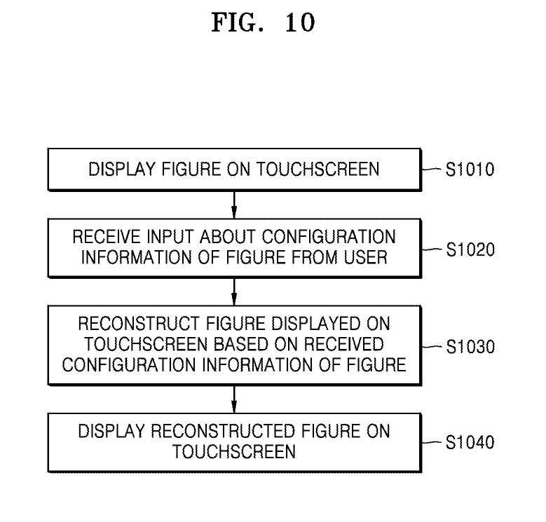

FIG. 10 is a flowchart of a process of editing a figure content according to an embodiment of the present disclosure.

Referring to FIG. 10, in operation S1010, the display unit may display a figure on the touchscreen. The displayed figure that is to be edited by the user may be a figure that is pre-drawn.

In operation S1020, the input device of the touchscreen apparatus may receive an input related to configuration information of the figure from the user. The configuration information of the figure may be length information and/or angle information.

In operation S1030, the control unit of the touchscreen apparatus may reconstruct the figure displayed on the touchscreen based on the received configuration information of the figure. The reconstructed figure may satisfy changed length information and/or angle information.

In operation S1040, the display unit of the touchscreen apparatus may display the reconstructed figure on the touchscreen. In this case, the figure before being reconstructed may be displayed along with the reconstructed (edited) figure.

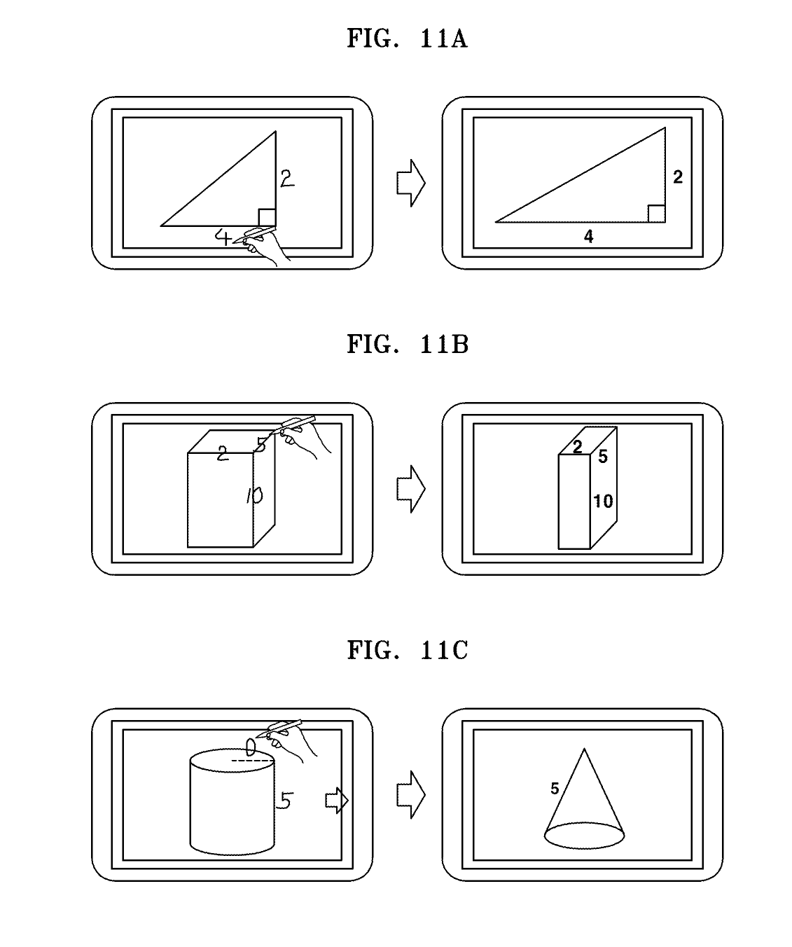

FIGS. 11A, 11B, and 11C are screens illustrating a method of editing a length of a figure content according to various embodiments of the present disclosure.

Referring to FIG. 11A, illustrated is a method of editing a length of a right triangle content. When a right triangle is displayed and length information of the right triangle is received from the user, the touchscreen apparatus may reconstruct (i.e., edit) the right triangle based on the received length information. The method has an advantage in that, because an accurate value for a figure that is input by the user, the figure may be quickly and accurately edited.

Referring to FIG. 11B, a solid figure may also be edited. The touchscreen apparatus may receive specific length information from the user and may reconstruct a figure content to satisfy the specific length information.

Referring to FIG. 11C, a type of a figure may be edited. When an input indicating that a radius of 0 for a top surface of a cylinder is received, the top surface of the cylinder changes to 0, thereby becoming a circular cone having no top surface. A height of the circular cylinder may be a length of an oblique side of the circular cone.

A solid figure may be reconstructed as a plane figure or a plane figure may be reconstructed as a solid figure. When length information of one dimension of a solid figure is input as 0 (for example, when a height of a square pillar is input as 0), the touchscreen apparatus may reconstruct the solid figure as a plane figure. In contrast, when length information indicating a height of a circle is input as a specific value, instead of 0, the touchscreen apparatus may reconstruct the circle as a cylinder. Since length information is input on a side of a figure or in an area within a predetermined distance from the side of the figure, the touchscreen apparatus may determine which side is to be edited according to an input location of the length information. Also, the input length information may include an equilateral symbol indicating a relative length to other sides.

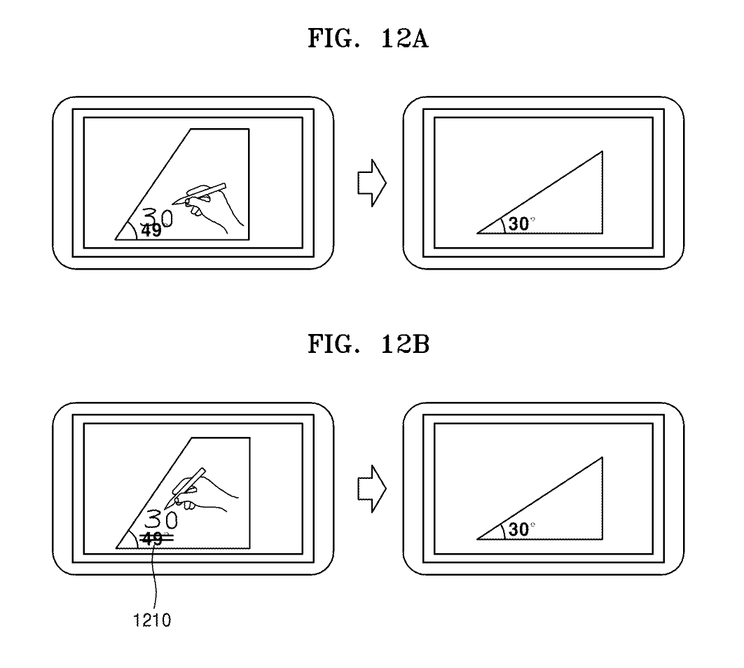

FIGS. 12A and 12B are screens illustrating a method of editing an angle of a figure content according to various embodiments of the present disclosure.

Similar to editing a length of a figure content, the touchscreen apparatus may be configured to edit angle information of a figure content.

Referring to FIG. 12A, the touchscreen apparatus may edit angle information by inputting a new angle to an angle that is already displayed. In FIG. 12A, when an angle of a quadrangle is edited from 49° to 30°, it may be unclear which angle is to be used to reconstruct the quadrangle. For example, when the touchscreen apparatus edits an angle to 30° by using an oblique side as reference information, the touchscreen apparatus may reconstruct the quadrangle as another type of quadrangle. When the touchscreen apparatus edits an angle to 30° by using a bottom side as reference information, the touchscreen apparatus may reconstruct the quadrangle as a right triangle. When an input about an angle having a bottom side as one side is input, it is preferable that the touchscreen apparatus reconstructs a figure by using the bottom side as reference information (without changing a length of the bottom side). Also, angle information may be input in an area within a predetermined distance from a vertex of the angle, and, thus, the angle to be changed can be determined. Also, angle information may be input as angle information indicating a specific value or may be input as a preset angle mark such as a right angle.

Referring to FIG. 12B, the touchscreen apparatus may receive an editing symbol for existing angle information and may then receive new angle information. The editing symbol corresponds to a command to enter an edit mode in which a figure content is to be edited. Accordingly, when an editing symbol is received, the touchscreen apparatus may display that a value of the side or the angle may be changed on the touchscreen.

The editing symbol may be input as any of various types to the touchscreen apparatus. For example, a mark such as “−”, “=”, “@”, or “X” may be input onto a length or an angle that is displayed on the touchscreen. The touchscreen apparatus may display an appropriate value range of the side or the angle to which the editing symbol is input. For example, when an editing symbol is input to a length of 5 in a right triangle whose three sides have lengths of 3, 4, and 5, the touchscreen apparatus may display on the touchscreen information saying, for example, “please input a value ranging from 1 to 7”. Alternatively, when an editing symbol is input to an angle of 30° in a right triangle whose three interior angles are 30°, 60°, and 90°, the touchscreen apparatus may display on the touchscreen information saying, for example, “please input a value so that a sum of three interior angles is 180°”.

An editing symbol 1210 may be used to indicate information to be edited. Since the editing symbol 1210 may be determined as a specific value on the touchscreen, when the editing symbol 1210 is input in a state where the auxiliary button of the input tool is pressed, it may be determined that the information to be edited is indicated.

The methods of editing length information and angle information of FIGS. 11A, 11B, 12A, and 12B may be performed in a similar manner to the above method of drawing a figure content. An input that eliminates a part or the whole of configuration information of a figure may be received and existing configuration information may be edited. For example, a triangle may be edited by eliminating length information including lengths of three sides of the triangle is eliminated and receiving new length information. Alternatively, a figure may be edited by eliminating only some length information and receiving new length information.

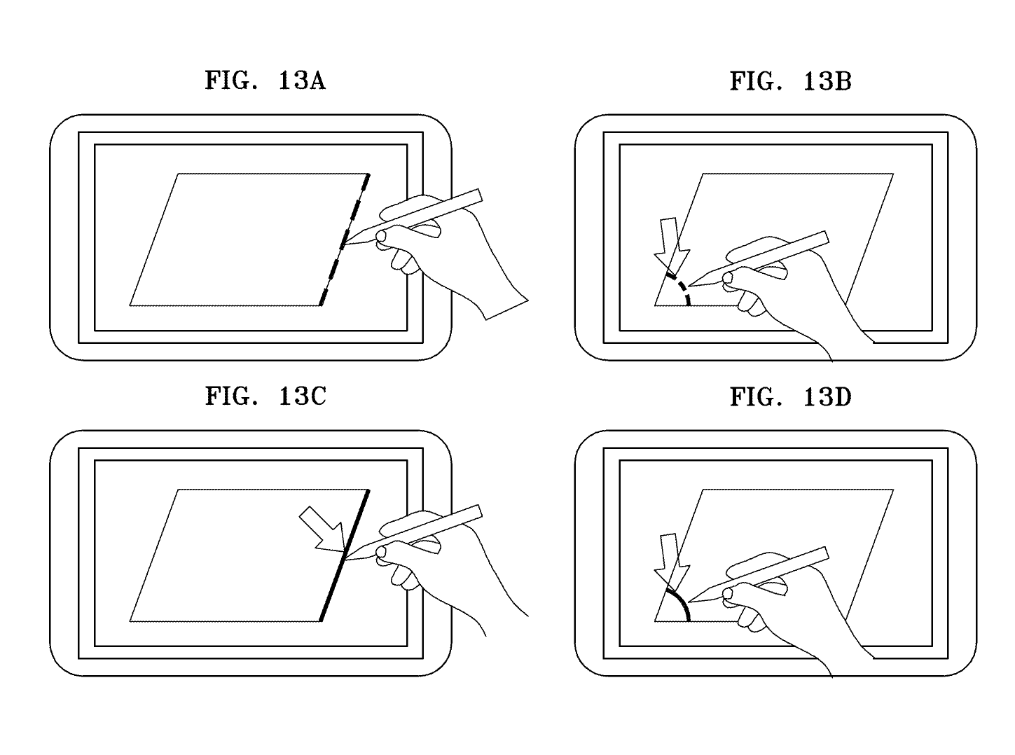

FIGS. 13A, 13B, 13C, and 13D are screen illustrating a method of editing a figure content according to various embodiments of the present disclosure.

Referring to FIGS. 13A, 13B, 13C, and 13D, an editable portion in a figure content may be displayed. Referring to FIGS. 13A and 13B, an editable side or angle may be displayed with a dashed line to be distinguished from other sides or angles. Referring to FIGS. 13C and 13D, an editable portion may also be indicated by using an indicator such as an arrow. Alternatively, the touchscreen apparatus may display a figure content so that a thickness or a color of a changeable portion (side or angle) is different from those of other portions and the user may edit the changeable portion.

Such a mark may be displayed without restrictions and may be set to be displayed when information is received indicating that the input tool of the user approaches a figure content displayed on the touchscreen.

Even when a figure content is edited, properties of a figure are maintained, such as when a figure content is drawn. Accordingly, when configuration information is received that does not satisfy properties of a figure, the touchscreen apparatus may determine that the figure may not be reconstructed and may display an object indicating that the figure is not drawn on the touchscreen. The object may be text such as “input is invalid” or an image such as “X”, a sound, or a vibration.

For example, text information saying, for example, “invalid length is input”, may be displayed on the touchscreen, and the displayed text information may be output on the touchscreen apparatus as any of various types such as a voice or a vibration. The control unit displays an appropriate range of length information to receive the length information satisfying properties of a figure content. Alternatively, the touchscreen apparatus may display text information saying, for example, “invalid angle is input”. The control unit of the touchscreen apparatus may display a popup message or the like to request the user to input angle information satisfying properties of a figure content. When two interior angles of a triangle are displayed as 30° and 60°, the control unit may automatically calculate the remaining interior angle as 90° according to properties of a triangle. Accordingly, the control unit may additionally perform a process of determining whether an angle that is input by the user is 90°.

A method of displaying information about a figure content will now be explained.

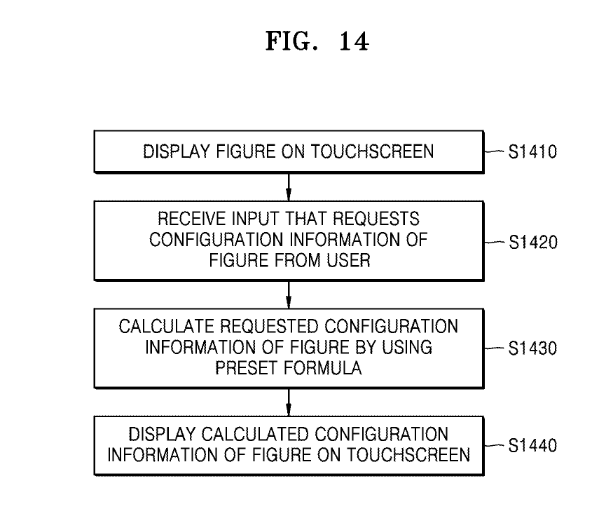

FIG. 14 is a flowchart of a process of displaying information about a figure content according to an embodiment of the present disclosure.

Referring to FIG. 14, in operation S1410, the display unit of the touchscreen apparatus may display a figure. The figure may be a plane figure or a solid figure.

In operation S1420, the input device may receive a request input related to configuration information of the figure from the user. When the figure is a plane figure, length information, angle information, and area information may be information that may be requested, and when the figure is a solid figure, a volume, and a surface area as well as length information, angle information, and area information may be requested.

In operation S1430, the control unit of the touchscreen apparatus may calculate the requested configuration information by using a preset formula. The preset formula may be, for example, the Pythagorean Theorem or a formula for obtaining an area of a triangle, and may be pre-stored in the storage unit of the touchscreen apparatus.

In operation S1440, the display unit of the touchscreen apparatus may display the figure based on the calculated configuration information. Only the requested configuration information may be displayed, or all configuration information may be displayed as a list.

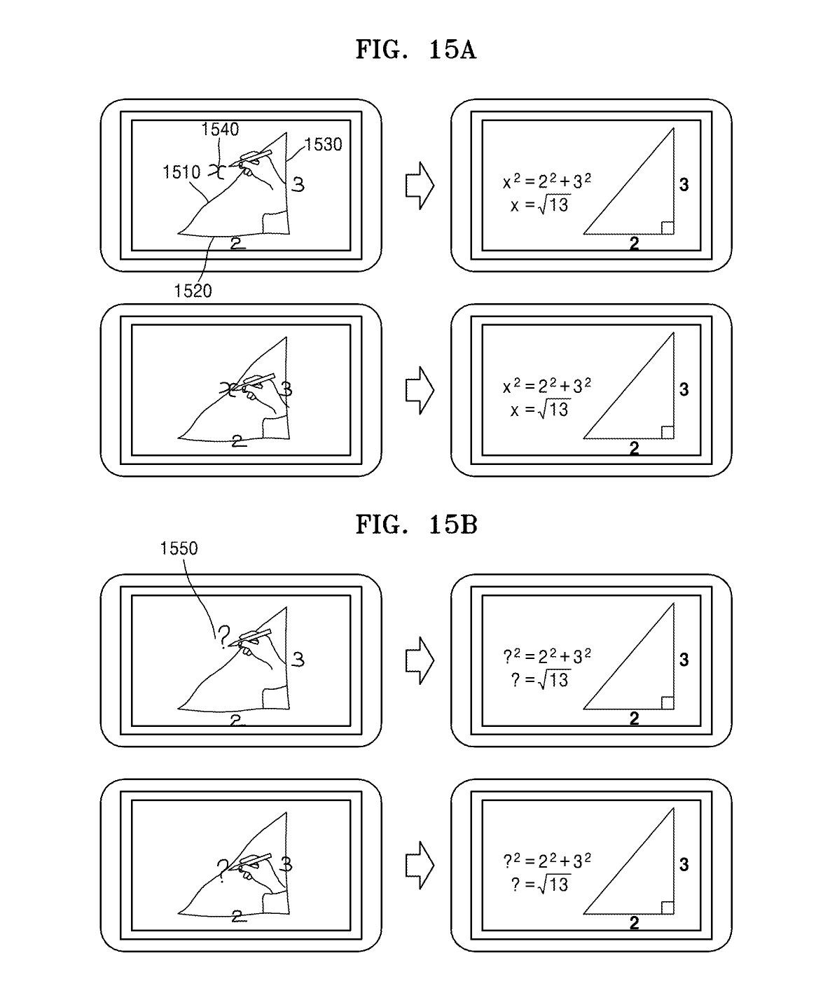

FIGS. 15A and 15B are screens illustrating a method of displaying information about a figure content according to various embodiments of the present disclosure.

Referring to FIG. 15A, a request input related to length information for configuration of a figure may be received. When an input indicating that a length of a bottom side 1520 is 2 and a height 1530 is 3 is received from the user, the touchscreen apparatus may calculate a length of an oblique side 1510 by using the Pythagorean Theorem. In this case, the requested length of the oblique side may be input as request text such as “x” 1540. Referring to FIG. 15B, the requested length of the oblique side may be input as another type of request text such as “?” 1550.

A request input is a command to display information related to a figure content that is drawn by the user. Once the request input is received, various information about a figure content may be displayed and information that may be calculated by the touchscreen apparatus.

For example, length information or angle information of a figure content may be displayed. When a quadrangle is input by the user, length information may be displayed based on coordinates of four edges of the quadrangle. Also, when a content whose two sides meet each other is input by the user, an angle between the two sides may be displayed on the touchscreen.

When a request input is received, the control unit may calculate length information and angle information of a figure content and may control an area of the figure content, a volume (i.e., when the figure content is a solid figure content), a length of a circumference, the number of sides, the number of intersections, information related to similar figure content, styling attribute information, an extension line of the figure content, and/or information of the figure content to be calculated and displayed.

A text input may be confused with length information or angle information of a figure content. For example, when the user inputs “x” to an oblique side that is intended to calculate a length of that oblique side, the touchscreen apparatus may determine “x” as text information indicating length information. In this case, when request text is received when the auxiliary button of the input tool is pressed, the touchscreen apparatus may determine the text as a request input and may calculate configuration information. It will be understood that a request input is not limited to text and may be any of various patterns defined by the user. Even when the user inputs a predefined pattern at a predetermined location on the touchscreen or applies a physical key input to the touchscreen apparatus, the touchscreen apparatus may determine that the request input is received.

The control unit of the touchscreen apparatus may calculate an oblique side by using Equation 1 (the Pythagorean Theorem).

Length of oblique side²=length of bottom side²+height² Equation 1

When Equation 1 and information indicating that a length of a bottom side is 2 and a height is 3 are used, since a square of the length of the oblique side is 13 (=2²+3²) and the length of the oblique side is greater than 0, \sqrt{13} may be calculated.

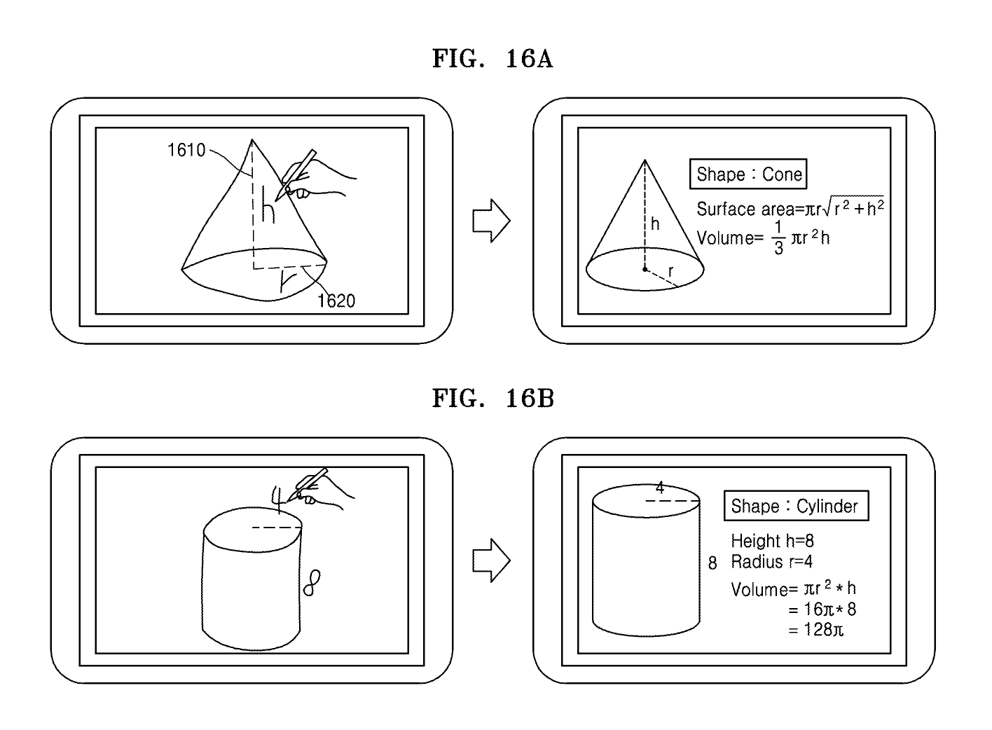

FIGS. 16A and 16B are screens illustrating a method of displaying information about a solid figure content according to various embodiments of the present disclosure.

Referring to FIG. 16A, a screen illustrate a method of calculating information related to a circular cone. The input device of the touchscreen apparatus may receive an auxiliary line input and length information indicating that a height 1610 is “h” and a radius 1620 of a bottom surface that is a circle is “r” in the circular cone from the user. The touchscreen apparatus may display on the touchscreen information about the circular cone based on the length information.

Equations 2 and 3 are formulas for obtaining a surface and a volume of the circular cone.

Surface of the circular cone: Surface_of_circular_cone=πr\sqrt{r²+h²}, Equation 2

where π is a ratio of a circumference of a circle to a diameter, r is a radius, and h is a height.

Volume of the circular cone: Volume_of_circular_cone=⅓πr²h, Equation 3

where π is a ratio of a circumference of a circle to a diameter, r is a radius, and h is a height.

Referring to FIG. 16B, a screen illustrates a method of calculating information related to a cylinder. The touchscreen apparatus may receive configuration information of the circular cylinder having a top surface whose radius is 4 and a height of 8 from the user. The touchscreen apparatus may calculate and display information about the circular cylinder based on received length information. Equation 4 is a formula for obtaining a volume of the circular cylinder.

Volume of the circular cylinder: Volume_of_cylinder=πr²h, Equation 4

where π is a ratio of a circumference of a circle to a diameter, r is a radius, and h is a height.

Accordingly, the control unit may calculate the volume of the circular cylinder as 128π by substituting the received length information into the formula to obtain the volume of the cylinder. The touchscreen apparatus may display the calculated volume on the touchscreen. The touchscreen apparatus may calculate and display a surface area as well as the volume of the cylinder. Equation 5 is a formula for obtaining the surface area of the cylinder.

Surface area of the circular cylinder: Surface_of_cylinder=2πrh+2πr², Equation 5

where π is a ratio of a circumference of a circle to a diameter, r is a radius, and h is a height.

Accordingly, the touchscreen apparatus may calculate the surface area of the cylinder as 96π and may display the surface area of 96π on the touchscreen. Information related to a figure may be set so that the display unit of the touchscreen apparatus displays only information requested by the user or all information related to the figure as a list.

The following equations that are configuration information of a figure content may be stored in the storage unit of the touchscreen apparatus. The control unit of the touchscreen apparatus may calculate various information by using the following equations.

i) Equation 6 is a formula for obtaining an area of a triangle.

Area of the triangle: area_of_triangle=½ah Equation 6

where a is a bottom side and h is a height.

ii) Equation 7 is a formula for obtaining a circumference l of a circle.

Circumference: l=2πr Equation 7

where π is a ratio of a circumference of a circle to a diameter and r is a radius.

iii) Equation 8 is a formula for obtaining an area of a circle.

Area of the circle: area_of_circle=πr² Equation 8

where π is a ratio of a circumference of the circle to a diameter and r is a radius.

iv) Equation 9 is a formula for obtaining a length l of an arc.

$$Length of the arc \text{:} l = 2 π r \times \frac{x °}{360 °} \qquad Equation 9$$

where π is a ratio of a circumference of a circle to a diameter, r is a radius, and x is a central angle.

v) Equation 10 is a formula for obtaining an area of a sector.

$$Area of the sector \text{:} area\_of \_sector = π {r}^{2} \times \frac{x °}{360 °} = \frac{1}{2} rl \qquad Equation 10$$

where π is a ratio of a circumference of a circle to a diameter, r is a radius, x is a central angle, and l is a length of an arc.

vi) Equation 11 is a formula for obtaining an area of a trapezoid.

$$Area of the trapezoid \text{:} area\_of \_trapezoid = \frac{( a + b )}{2} h \qquad Equation 11$$

where a is a top side, b is a bottom side, and h is a height.

vii) Equation 12 is a formula for obtaining a surface area of a globe.

Surface area of the globe: Surface_of_globe=4πr² Equation 12

where π is a ratio of a circumference of a circle to a diameter and r is a radius.

viii) Equation 13 is a formula for obtaining a volume of a globe.

Volume of the globe: Volume_of_globe= 4/3πr³ Equation 13

where π is a ratio of a circumference of a circle to a diameter and r is a radius.

Configuration information of a figure is not limited to information calculated by using the above equations, and various other mathematical formulas for calculating configuration information of a figure may be stored in the storage unit of the touchscreen apparatus.

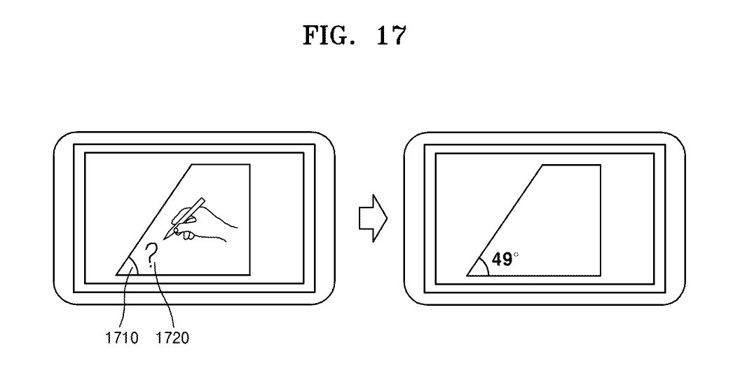

FIG. 17 is a screen illustrating a method of displaying angle information of a figure content according to an embodiment of the present disclosure.

The touchscreen apparatus may display configuration information in response to a request of the user for the configuration information of the figure content. Referring to FIG. 17, after an angle 1710 about the figure content is input, when request text such as “?” 1720 is input, the touchscreen apparatus may determine that a value of the angle mark 1710 is requested. Accordingly, the control unit may calculate the angle 1710 by using a length of a side and a coordinate value of the side. In FIG. 17, the angle 1710 may be calculated by using an arctangent function.

Even when request text related to a length of the figure content is displayed on the touchscreen is input, the length information may be displayed. Angle information is not related to a size of the figure content. However, as for length information, a length displayed on the touchscreen and a length that is actually input may be different from each other, and thus a ratio thereof may also be displayed.

A user environment (e.g., a user interface (UI) and a user experience (UX)) in a digital device having various functions is an important issue. For example, when a smart television (TV), instead of a TV of the related art, is used in a living room of an ordinary home, it is important for the user to conveniently use various functions provided by the smart TV. The smart TV may also include various Internet-based contents, which have been used in a PC, such as Internet web surfing, e-mail, games, photos, music, and video media. If the various contents make the user feel uncomfortable, the usefulness of the smart TV is reduced. In this regard, when an apparatus and method of providing a GUI according to the one or more embodiments of the present disclosure are applied to a multimedia device such as a smart TV, user convenience may be improved.

The present disclosure may be embodied as processor-readable codes in a recording medium that may be read by a processor provided in a digital device such as a central processing unit (CPU). The processor-readable recording medium may be any recording medium capable of storing data that is read by a processor. Examples of the processor-readable recording medium include read-only memories (ROMs), random-access memories (RAMs), compact disc ROMs (CD-ROMs), magnetic tapes, and floppy disks. The processor-readable medium may be distributed among computer systems that are interconnected through a network, and the present disclosure may be stored and implemented as processor-readable codes in the distributed system. Functional programs, codes, and code segments for embodying the present disclosure may be derived in the technical field to which the present disclosure pertains.

A method of drawing a figure content, a method of editing a figure content, and a method of displaying information about a figure content may be embodied as one SW program, or all or some of the methods may be implemented as various SW functional modules and may be performed in an operating system (OS). For example, a method of drawing a figure content may be embodied as one SW program, each operation of a method of drawing a figure content may be implemented as one SW functional module, or operations of a method of drawing a figure content may be combined and may be implemented as one SW functional module and may be performed in an OS.

Accordingly, although various embodiments are not implemented as one SW functional module, as long as various SW functional modules may perform each operation of the present disclosure and operate in one OS, it will be understood that a method of drawing a figure content, a method of editing a figure content, or a method of displaying information about a figure content is embodied.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of drawing a figure content on a apparatus, the method comprising:
receiving a touch input of a figure from a user;
receiving an input related to configuration information of the figure;
reconstructing a figure, which is pre-stored, based on at least one of the received touch input and the received configuration information of the figure to form a reconstructed figure; and
displaying the reconstructed figure on a touchscreen,
wherein the configuration information of the figure comprises at least one of information indicating a length of the figure and information indicating an angle of the figure.

2. The method of claim 1, wherein the received touch input of the figure comprises at least one of a swipe input that draws a side of a figure to be drawn and a touch input that selects a figure that is pre-stored in the apparatus.

3. The method of claim 1, further comprising displaying information of the touch input on the touchscreen.

4. The method of claim 1, further comprising, when it is determined that the figure that is pre-stored is not reconstructable based on at least one of the received touch input and the received configuration information of the figure, displaying an object indicating that no figure is drawn on the touchscreen.

5. The method of claim 1, wherein the receiving of the input related to the configuration information of the figure further comprises, when the configuration information of the figure is length information, receiving the input related to the configuration information of the figure on a side of the figure or in an area within a predetermined distance from the side of the figure.

6. The method of claim 5, wherein the length information comprises at least one of a value of a length of the side of the figure and a preset object indicating a relative length to other sides.

7. The method of claim 1, wherein the receiving of the input related to the configuration information of the figure further comprises, when the figure is a circular figure, receiving an input related to an auxiliary line indicating a diameter or a radius of the circular figure and then receiving length information indicating the diameter or the radius of the circular figure.

8. The method of claim 1, wherein the receiving of the input related to the configuration information of the figure further comprises, when the figure is a solid figure, receiving an input related to an auxiliary line indicating a height of the solid figure and then receiving length information indicating the height of the solid figure.

9. The method of claim 1, wherein the receiving of the input related to the configuration information of the figure further comprises, when the configuration information of the figure is angle information, receiving the input related to the configuration information of the figure in an area with a predetermined distance from a contact point at which two sides constituting the angle information meet each other.

10. The method of claim 9, wherein the angle information comprises at least one of a value of an angle and a preset angle marking object.

11. A method of editing a figure content on a touchscreen apparatus, the method comprising:
displaying a figure on a touchscreen;
receiving an input related to configuration information of the figure from a user;
reconstructing the figure displayed on the touchscreen based on the received configuration information of the figure to obtain a reconstructed figure; and
displaying the reconstructed figure on the touchscreen,
wherein the configuration information of the figure comprises at least one of information indicating a length of the figure and information indicating an angle of the figure.

12. The method of claim 11, wherein the received input related to the configuration information of the figure comprises at least one of a swipe input of a side of a figure to be edited and a touch input that selects a figure that is pre-stored in the touchscreen apparatus.

13. The method of claim 11, further comprising receiving a touch input that eliminates a part or the whole of the configuration information of the figure displayed on the touchscreen.

14. The method of claim 11, wherein when it is determined that the pre-stored figure is not reconstructable based on the received configuration information of the figure, the method comprises displaying an object indicating that no figure is drawn on the touchscreen.

15. The method of claim 11, wherein the receiving of the input related to the configuration information of the figure comprises, when the configuration information of the figure is length information, receiving the input related to the configuration information of the figure on a side of the figure or in an area within a predetermined distance from the side of the figure.

16. The method of claim 15, wherein the length information comprises at least one of a value of a length of the side of the figure and a preset object indicating a relative length to other sides.

17. The method of claim 11, wherein the receiving of the input related to the configuration information of the figure comprises, when the figure is a circular figure, receiving an input related to an auxiliary line indicating a diameter or a radius of the circular figure and then receiving length information indicating the diameter or the radius of the circular figure.

18. The method of claim 11, wherein the receiving of the input the configuration information of the figure comprises, when the figure is a solid figure, receiving an input an auxiliary line indicating a height of the solid figure and then receiving length information indicating the height of the solid figure.

19. The method of claim 11, wherein the receiving of the input the configuration information of the figure comprises, when the configuration information of the figure is angle information, receiving the input related to the configuration information of the figure in an area within a predetermined distance from a contact point at which two sides constituting the angle information meet each other.

20. The method of claim 19, wherein the angle information comprises at least one of a value of an angle and a preset angle marking object.

21. A method of displaying information related to a figure content on a touchscreen, the method comprising:
displaying a figure on a touchscreen;
receiving an input that requests for configuration information of the figure;
calculating the requested configuration information of the figure by using a preset formula; and
displaying the calculated configuration information of the figure on the touchscreen,
wherein the configuration information of the figure comprises at least one of information indicating a length of the figure and information indicating an angle of the figure.

22. The method of claim 21, wherein the requested configuration information of the figure comprises at least one of length information, angle information, area information, and volume information of the figure.

23. The method of claim 21, wherein the receiving of the input that requests for the configuration information of the figure comprises receiving an input related to a request object or preset request text.

24. The method of claim 21, wherein the receiving of the input that requests for the configuration information of the figure comprises, when the requested configuration information of the figure is length information, receiving the input that requests for the configuration information of the figure on a side of the figure or in an area within a predetermined distance from the side of the figure.

25. The method of claim 21, wherein the receiving of the input that requests for the configuration information of the figure comprises, when the requested figure is a circular figure, receiving an input related to an auxiliary line indicating a diameter or a radius of the circular figure and then receiving an input that requests for length information indicating the diameter or the radius of the circular figure.

26. The method of claim 21, wherein the receiving of the input that requests for the configuration information of the figure comprises, when the requested figure is a solid figure, receiving an input related to an auxiliary line indicating a height of the solid figure and then receiving an input that requests for length information indicating the height of the solid figure.

27. The method of claim 21, wherein the receiving of the input that requests for the configuration information of the figure comprises, when the configuration information of the figure is angle information, receiving the input that requests for the configuration information of the figure in an area within a predetermined distance from a contact point at which two sides constituting the angle information meet each other.

28. A touchscreen apparatus for drawing a figure content, the touchscreen apparatus comprising:
an input device configured to receive a touch input of a figure from a user and receive an input related to configuration information of the figure;
a processor configured to reconstruct the figure, which is pre-stored, based on at least one of the received touch input and the received configuration information of the figure to obtain a reconstructed figure; and
a display configured to display the reconstructed figure on a screen,
wherein the configuration information of the figure comprises at least one of information indicating a length of the figure and information indicating an angle of the figure.

29. A touchscreen apparatus for editing a figure content, the touchscreen apparatus comprising:
an input device configured to receive an input related to configuration information of a figure from a user;
a processor configured to reconstruct the figure displayed on a touchscreen based on the received configuration information of the figure to obtain a reconstructed figure; and
a display configured to display the reconstructed figure on the touchscreen,
wherein the configuration information of the figure comprises at least one of information indicating a length of the figure and information indicating an angle of the figure.

30. A touchscreen apparatus for displaying information related to a figure content, the touchscreen apparatus comprising:
an input device configured to receive an input that requests for configuration information of a figure;
a processor configured to calculate the requested configuration information of the figure by using a preset formula; and
a display configured to display the calculated configuration information of the figure on a touchscreen,
wherein the configuration information of the figure comprises at least one of information indicating a length of the figure and information indicating an angle of the figure.

31. A non-transitory computer-readable storage medium storing one or more programs, the one or more programs comprising instructions, which when executed by a device with a touchscreen, cause the device to execute the method of claim 1.
